(19) United States
(12) Patent Application Publication
(10) Pub. No.: US 2011/0061696 A1
(43) Pub. Date: Mar. 17, 2011

(54) Cane holder

(76) Inventor: Daniel Eugene Wilson, San Leandro, CA (US)

(21) Appl. No.: 12/584,717

(22) Filed: Sep. 11, 2009

(51) Int. Cl. A45B 3/00; F16M 13/00

(52) U.S. Cl. 135/66; 248/304

(57) ABSTRACT

An accessory to provide a user with hands-free placement of a cane includes a hook with a curved body to be mounted on the cane and below a cane handle, and a tip adapted to be received in a pocket or a pouch affiliated with the user to provide hands-free operation; and a cane interface pad positioned between the curved body and the cane.

This application claims priority to U.S. Provisional Application Ser. No. 61/191,423 filed Sep. 9, 2008, the content of which is incorporated by reference.

### BACKGROUND

Many people have some form of physical handicap which limits their mobility, and who require some form of mechanical aid or assistance for their movement. In many cases, the physical infirmity is not so severe as to require a wheelchair or similar device for mobility; many times, the handicapped person has limited use of his or her legs, and can get around reasonably well with the use of one or more crutches, canes, a walker, etc. In some instances, a person may require only a single cane, at least for some limited mobility.

In recent years, the number of persons who might require the assistance of a cane while walking has increased significantly. Such increase is due primarily to the gradual overall aging of the population, which in turn can be attributed in large degree to significant advances in medicine and generally improved living conditions. However, such medical advances have also allowed younger individuals suffering from particular maladies or who are partially incapacitated as a result of an accident or other happening, which persons might otherwise be incapable of walking or moving around at all, to regain at least some of their mobility more quickly than in the past with the assistance of a device such as a cane.

Although canes can be enormously effective in aiding one's mobility by partially transferring the user's weight from the legs to the arms as well as by steadying such person, in effect providing three legs rather than only two, most cane users also find that it is desirable to have a means for quickly and effectively temporarily storing such cane when it is not in use. For example, during times when the user is sitting down or in a resting position, the cane is not required to be used, but preferably should be stored within easy reach of the user for convenient retrieval when such cane is again required for use. However, often there is no convenient or practical place to store or rest the cane within easy reaching distance. If the cane is placed temporarily aside, older users not only may forget where it was placed, but the cane may be precariously placed, and when an attempt is made to recover it, frequently it will be just out of reach or may have been knocked down or over or may have slid to the floor where it can itself constitute a tripping hazard. In addition, many cane users do not have the ability, vision, or range of motion to easily walk, bend, or otherwise move to recover a cane which may have been resting against a wall and fallen to the floor, whereupon it may have become a tripping hazard or danger itself, not only to the user, but to others. Not infrequently, the cane user himself or herself may knock over a standing cane and then have difficulty in recovering it, or even be unable to recover it, from the floor. On the other hand, a cane user often does not wish to hold the cane when it is not required, as he or she wishes to have his or her hands free to perform other tasks, such as preparing food, opening medicine bottles, eating, writing, using the telephone, or sometimes the cane owner simply wants to rest without having to grasp the cane.

While various approaches have been attempted and frequently adopted for either holding a cane nearby the user or in a vertical position or both, there are also a wide variety of sizes, shapes, styles and other structural differences between canes. Often, a user will have several different canes, each having slightly different dimensions. For example, while most canes have a generally rounded shaft, others may have a generally oval or even square or rectangular shape. There is also a wide variance in the types of handles among different canes, as well as differences in the diameters of the shafts of canes. Thus, any holding device for canes must be able to be used on a variety of differently dimensioned canes. Such device should preferably also be able to hold the cane clear of the floor while standing and relatively close to the owner and more or less upright when sitting in order to prevent a tripping hazard.

U.S. Pat. No. 6,997,362 discloses a cane holding device for temporarily holding a cane in close proximity to the body of the user comprising a cane engaging member having at least two interconnected apertures for holding canes of different shapes and sizes, and a lanyard securable around the neck of the user for holding the cane engaging member. The material from which the cane holder is formed is resilient to allow a cane to be pressed from one aperture or orifice in the cane holder to another.

### SUMMARY

1. An accessory to provide a user with hands-free placement of a cane, comprising:
a. a hook including
   i. a curved body to be mounted on the cane and below a cane handle, and
   ii. a tip adapted to be received in a pocket or a pouch affiliated with the user to provide hands-free operation; and
b. a cane interface pad positioned between the curved body and the cane.

2. The accessory of claim 1, comprising a foot pad at the tip.

3. The accessory of claim 2, wherein the foot pad comprises rubber.

4. The accessory of claim 2, wherein the foot pad comprises acrylic tape.

5. The accessory of claim 1, wherein the pocket comprises a pant pocket or a shirt pocket.

6. The accessory of claim 1, wherein the pocket comprises a pocket on a purse.

7. The accessory of claim 1, wherein the cane interface pad comprises a tape.

8. The accessory of claim 7, wherein the cane interface pad is installed on the cane to keep the cane from touching the ground during hands-free placement.

9. An accessory to provide a user with hands-free placement of a cane, comprising:
a. a hook including
   i. a curved body to be mounted on the cane and below a cane handle, and
   ii. a tip adapted to be received in a pocket on the user to provide hands-free operation;
   iii. a foot pad at the tip to provide traction when the tip is positioned on a flat surface; and
b. a cane interface pad positioned between the curved body and the cane.

10. The accessory of claim 9, wherein the foot pad comprises rubber.

11. The accessory of claim 9, wherein the foot pad comprises acrylic tape.

12. The accessory of claim 9, wherein the pocket comprises a pant pocket or a shirt pocket.

13. The accessory of claim 9, wherein the pocket comprises a pocket on a purse.

14. The accessory of claim 9, wherein the cane interface pad comprises a tape.

15. The accessory of claim 9, wherein the cane interface pad is installed on the cane to keep the cane from touching the ground during hands-free placement.

16. A method for providing hands-free operation with a cane accessory including a hook, a curved body, a tip adapted to be placed in a pocket or pouch, and a cane interface pad, the method comprising:
a. determining a position of the cane interface pad so that cane hook is not dragging on the ground while at pocket height during installation;
b. adjusting the position so that the cane bottom clears table height or rest room height;
c. mounting the cane interface pad below a cane handle at the position between the curved body and the cane; and
d. placing the tip in the pocket or pouch to provide hands-free operation.

17. The method of claim 16, comprising testing the hook in different locations for individual tastes.

18. The method of claim 16, comprising forming a foot pad at the tip bottom to provide traction.

19. The method of claim 16, comprising permanently mounting the cane hook in the predetermined position.

20. The method of claim 16, comprising painting the cane accessory to match the cane color.

21. (TO BE UPDATED ONCE FINALIZED)

Advantages of the cane hook may include one or more of the following. The cane hook can hang from the user's pocket or purse when the user needs to be hands-free. The acrylic cane hook allows the user to become hands free when needed, for example when shopping, on the phone, loading groceries or whenever two hands are needed. The cane will always be within reach! The cane hook is perfect for left or right handed users. The cane hook also provides a sanitary and safer option for the user's hands. The cane handle is insulated and does not touch potentially grimy surfaces, since the cane hook is mounted below the handle. A rubber tip allows the cane to hang from a table or a flat surface while the user is seated. The quick mounting pad or tape allows the user to experiment where to place the cane hook since everyone's pockets or tables have a different height.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1A shows a top view of a first cane holder embodiment.

FIG. 1B shows a side view of a first cane holder embodiment.

FIG. 1C shows a front view of a first cane holder embodiment.

FIG. 2A and FIG. 2B show top views of a second cane holder embodiment.

FIG. 2C shows a side view of a second cane holder embodiment.

### DESCRIPTION

The following detailed description is of the best mode or modes of the invention presently contemplated. Such description is not intended to be understood in a limiting sense, but to be an example of the invention presented solely for illustration thereof, and by reference to which in connection with the following description and the accompanying drawings one skilled in the art may be advised of the advantages and construction of the invention.

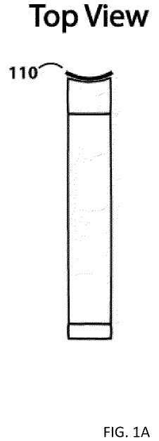

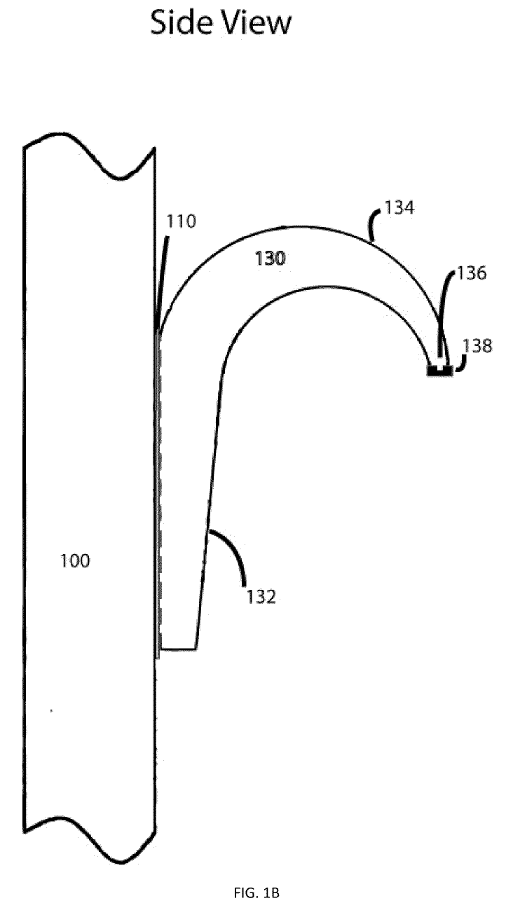

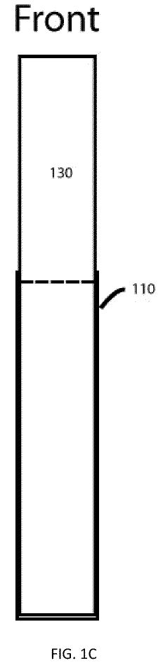

FIG. 1A shows a top view of a first cane holder embodiment, while FIG. 18 shows a side view of a first cane holder embodiment and FIG. 1C shows a front view of a first cane holder embodiment. In one embodiment, the cane 100 is cylindrical. The cane holder of FIGS. 1A-1C is adapted to be secured to a cane 100 through an interface pad 110. The other side of the cane holder pad 110 is attached to a body 132 with a curved hook 130. The concave curvature of the body of the hook body allows the cane hook to be easily mounted on any cane. The cane hook is an accessory that fits virtually all canes.

At one end of the hook 130 is a recessed region 136 which is adapted to support a hook foot pad 138. In one embodiment, the foot pad 138 is an acrylic tape on the top of the cane hook that provides traction on slippery surfaces such as glass. In another embodiment, the foot pad 138 can be rubber or other suitable elastic substances that provide a connecting surface, which allows the foot pad to affix firmly to the cane 100 through the hook 130 and provide a better supporting effect. Due to the elasticity of the foot pad and its contact against an outer supporting surface, an anti-skid effect of the foot pad is improved and the foot pad is capable of absorbing the deformation so as to ensure stability when using the cane 100.

During installation, the user locates the appropriate location for the cane holder pad 110 on the cane 100 and the cane hook body 132. Preferably, the bottom of the cane 100 is not touching or dragging on the ground when the hook is hooked on a pocket or a recess to free the user's hand. This can be done by testing the hook in different locations for individual tastes. The user should set the height so the cane hook is not dragging on the ground while at pocket height. The user should set the location of the cane holder pad 110 such that the cane 100 clears table and rest room heights as well. During the installation, the acrylic tape does not solidify and allows relocation as long as it is kept clean. Once the location is determined, the user can then use a clear cement or high strength glue to permanently mount the handy cane hook in the desired location.

In one embodiment, the cane hook 130 is clear acrylic. In other embodiment, the cane hook 130 can be painted to match cane color if desired.

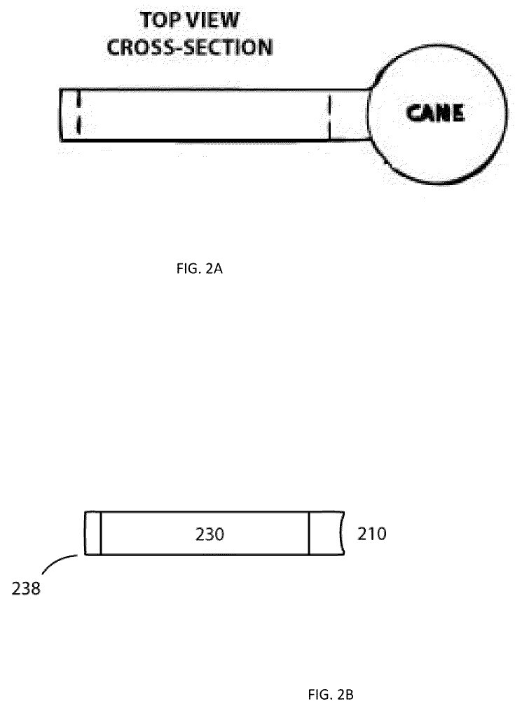

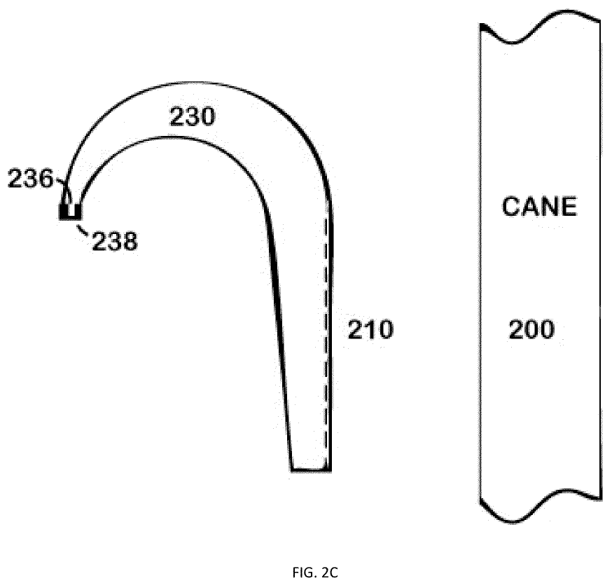

FIG. 2A shows a cross-sectional top view of a second cane holder embodiment. In this embodiment, a hook 230 is securely connected to a cane 200 through a tape or pad 210. The tip of the hook has a foot pad 238 that can be a material to provide traction for surfaces such as glass or plastic, among others. FIG. 2B shows another top view of a second cane holder embodiment.

FIG. 2C shows a side view of a second cane holder embodiment. As shown in FIG. 2C, the foot pad 238 is secured to the tip of the hook 230 with a recess 236 which is filled with the same material as the foot pad 238. In one embodiment, the tip of the hook 230 is immersed in a rubber or similar elastic material and after the immersion, the rubber fills the recess 236 and forms a seal on the outside of the tip at the same time. Also, the body of the cane hook is curved so that when the body is placed against the pad 210 and the cane 200, the pad 210 securely affixes the bottom of the cane hook to the curved surface of the cane.

As indicated above, the cane holder of the invention is not only utilitarian and practical but also can be decorative. For example, the plastic holder itself can be formed from various colors of plastic not only in solid colors, but because of the shape of the holder of mixtures of colors such as swirls, multi-colors, and the like. In addition, the lanyard can be made in various decorator fabric designs and colors including color coordination with the outfit of the user.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention.

What is claimed is:

1. An accessory to provide a user with hands-free placement of a cane, comprising:
a. a hook including
i. a curved body to be mounted on the cane and below a cane handle, and
ii. a tip adapted to be received in a pocket or a pouch affiliated with the user to provide hands-free operation; and
b. a cane interface pad positioned between the curved body and the cane.

2. The accessory of claim 1, comprising a foot pad at the tip.

3. The accessory of claim 2, wherein the foot pad comprises rubber.

4. The accessory of claim 2, wherein the foot pad comprises acrylic tape.

5. The accessory of claim 1, wherein the pocket comprises a pant pocket or a shirt pocket.

6. The accessory of claim 1, wherein the pocket comprises a pocket on a purse.

7. The accessory of claim 1, wherein the cane interface pad comprises a tape.

8. The accessory of claim 7, wherein the cane interface pad is installed on the cane to keep the cane from touching the ground during hands-free placement.

9. An accessory to provide a user with hands-free placement of a cane, comprising:
a. a hook including
i. a curved body to be mounted on the cane and below a cane handle, and
ii. a tip adapted to be received in a pocket on the user to provide hands-free operation;
iii. a foot pad at the tip to provide traction when the tip is positioned on a flat surface; and
b. a cane interface pad positioned between the curved body and the cane.

10. The accessory of claim 9, wherein the foot pad comprises rubber.

11. The accessory of claim 9, wherein the foot pad comprises acrylic tape.

12. The accessory of claim 9, wherein the pocket comprises a pant pocket or a shirt pocket.

13. The accessory of claim 9, wherein the pocket comprises a pocket on a purse.

14. The accessory of claim 9, wherein the cane interface pad comprises a tape.

15. The accessory of claim 9, wherein the cane interface pad is installed on the cane to keep the cane from touching the ground during hands-free placement.

16. A method for providing hands-free operation with a cane accessory including a hook, a curved body, a tip adapted to be placed in a pocket or pouch, and a cane interface pad, the method comprising:
a. determining a position of the cane interface pad so that cane hook is not dragging on the ground while at pocket height during installation;
b. adjusting the position so that the cane bottom clears table height or rest room height;
c. mounting the cane interface pad below a cane handle at the position between the curved body and the cane; and
d. placing the tip in the pocket or pouch to provide hands-free operation.

17. The method of claim 16, comprising testing the hook in different locations for individual tastes.

18. The method of claim 16, comprising forming a foot pad at the tip bottom to provide traction.

19. The method of claim 16, comprising permanently mounting the cane hook in the predetermined position.

20. The method of claim 16, comprising painting the cane accessory to match the cane color.
